(19) United States
(12) Patent Application Publication
(10) Pub. No.: US 2020/0275495 A1
(43) Pub. Date: Aug. 27, 2020

(54) Random Access Method, Spectrum Reporting Method, Terminal Device, and Network Device

(71) Applicant: GUANGDONG OPPO MOBILE TELECOMMUNICATIONS CORP., LTD., Dongguan (CN)

(72) Inventor: Ning Yang, Dongguan (CN)

(21) Appl. No.: 16/871,536

(22) Filed: May 11, 2020

Related U.S. Application Data
(63) Continuation of application No. PCT/CN2017/112941, filed on Nov. 24, 2017.

(51) Int. Cl. H04W 74/08; H04W 72/04

(52) U.S. Cl. CPC H04W 74/0833; H04W 72/0453

(57) ABSTRACT

Provided are a random access method, a spectrum reporting method, a terminal device, and a network device. The method comprises: a terminal device obtains a first frequency point by means of a cell search; the terminal obtains a first band supported by a network device by means of a system broadcast message; the terminal device determines, in a plurality of bands corresponding to the first frequency point, a second band supported by the terminal device; and the terminal device initiates a random access process when determining that the first band and the second band are the same.

### CROSS-REFERENCE TO RELATED APPLICATION(S)

The present application is a continuation application of International Application No. PCT/CN2017/112941 filed on Nov. 24, 2017, which is hereby incorporated by reference in its entirety.

### TECHNICAL FIELD

Implementations of the present disclosure relate to the field of communication, and more particularly, to a method for random access, a method for reporting a spectrum, a terminal device and a network device.

### BACKGROUND

With people's pursuit of rate, latency, high-speed mobility and energy efficiency, and diversity and complexity of services in future life, the International Standards Organization of 3rd Generation Partnership Project (3GPP) began to research and develop 5-Generation mobile communication technology (5G). In early deployment of New Radio (NR), complete NR coverage is difficult to achieve, and thus typical network coverage is of a mode of wide area coverage of Long Term Evolution (LTE) and island coverage of NR. Moreover, as a large amount of LTE applications are deployed below 6 GHz, there are few spectrums below 6 GHz that can be used for 5G. Therefore, application at a spectrum above 6 GHz must be researched for NR, however coverage of a high frequency band is limited and signal fading thereof is fast.

In some solutions, uplink coverage is limited as uplink power of a terminal device is limited and frequency of an NR spectrum is relatively high (propagation loss of high frequency is high). To improve the uplink coverage, an LTE spectrum (relatively low frequency) is used as a supplementary uplink spectrum (i.e., there is a supplementary uplink carrier), which can improve the uplink coverage.

However, in a scenario with the supplementary uplink (SUL), as there is no bandwidth configuration information in SUL configuration information, similarly, in a normal NR cell, a UE only acquires frequency point information of the cell from a cell search and there is no information about a downlink bandwidth of the cell.

Moreover, in a current frequency band configuration, there may be an overlap of frequency ranges between two frequency bands, that is, one frequency point corresponds to multiple frequency bands, while a terminal device may only support one of the multiple frequency bands. For example, the terminal device does not support a frequency band in which a frequency point of the NR cell is located, but supports another frequency band in which the frequency band is located. In other words, a network device does not know a spectrum range supported by the terminal device, thus, if scheduling of the terminal device by the network device exceeds the frequency range supported by the terminal device, data transmission and reception will fail.

### SUMMARY

A method for random access, a method for spectrum reporting, a terminal device and a network device are provided.

In a first aspect, a method for random access is provided. The method includes that a terminal device acquires a first frequency point through a cell search; the terminal device acquires a first frequency band supported by a network device through a system broadcast message; the terminal device determines a second frequency band supported by the terminal device among multiple frequency bands corresponding to the first frequency point; and the terminal device initiates a random access procedure when determining that the first frequency band and the second frequency band are the same frequency band.

In some possible implementations, the method further includes that when the first frequency band and the second frequency band are different frequency bands, the terminal device generates indication information, wherein the indication information is used for the network device to determine a schedulable spectrum range of the terminal device, or the indication information is used for indicating the spectrum range; and the terminal device sends the indication information to the network device.

In some possible implementations, the indication information is more specifically used for indicating that a frequency band supported by the terminal device is the second frequency band.

In some possible implementations, the spectrum range is a range formed by an overlapping spectrum of the first frequency band and the second frequency band.

In some possible implementations, before the terminal device generates the indication information, the method further includes that the terminal device receives first mapping relation information sent by the network device, wherein the first mapping relation information includes a corresponding relationship between the multiple frequency bands and multiple resources, and each of the multiple resources includes a preamble code and/or a physical random access channel (PRACH) resource; the terminal device determines a first resource corresponding to the second frequency band according to the second frequency band and the first mapping relation information; herein, sending, by the terminal device, the indication information to the network device includes that the terminal device initiates the random access procedure through the first resource and indicates through the first resource that a frequency band supported by the terminal device is the second frequency band.

In some possible implementations, before the terminal device generates the indication information, the method further includes that the terminal device receives second mapping relation information sent by the network device, wherein the second mapping relation information includes a corresponding relationship between a of plurality of indexes and the multiple frequency bands, and the multiple indexes are different from each other; the terminal device determines a first index corresponding to the second frequency band according to the second frequency band and the second mapping relation information; herein, sending, by the terminal device, the indication information to the network device includes that the terminal device sends the first index to the network device, and the first index is used for indicating that a frequency band supported by the terminal device is the second frequency band.

In some possible implementations, sending, by the terminal device, the indication information to the network device includes that the terminal device sends a Radio Resource Control (RRC) message to the network device, wherein the RRC message includes the indication information.

In a second aspect, a method for random access is provided. The method includes that a network device sends a first frequency band supported by the network device to a terminal device through system broadcast; and the network device responds to a random access procedure initiated by the terminal device.

In some possible implementations, the method further includes that the network device receives indication information sent by the terminal device, wherein the indication information is used for the network device to determine a schedulable spectrum range of the terminal device, or the indication information is used for indicating the spectrum range; herein, responding, by the network device, to the random access procedure initiated by the terminal device includes that the network device responds to the random access procedure according to the spectrum range.

In some possible implementations, the indication information is more specifically used for indicating that a frequency band supported by the terminal device is the second frequency band.

In some possible implementations, the spectrum range is a range formed by an overlapping spectrum of the first frequency band and a second frequency band.

In some possible implementations, before the network device receives the indication information sent by the terminal device, the method further includes that the network device sends first mapping relation information to the terminal device, wherein the first mapping relation information includes a corresponding relationship between the multiple frequency bands and multiple resources, and each of the multiple resources includes a preamble code and/or a physical random access channel (PRACH) resource; herein, receiving, by the network device, the indication information sent by the terminal device includes that the network device determines a first resource used when the terminal device initiates the random access procedure; the network device determines a second frequency band corresponding to the first resource as a frequency band supported by the terminal device according to the first mapping relation information.

In some possible implementations, before the network device receives the indication information sent by the terminal device, the method further includes that the network device sends second mapping relation information to the terminal device, wherein the second mapping relation information includes a corresponding relationship between multiple indexes and the multiple frequency bands, and the multiple indexes are different from each other; herein, receiving, by the network device, the indication information sent by the terminal device includes that the network device receives a first index sent by the terminal device; the network device determines a second frequency band corresponding to the first index as a frequency band supported by the terminal device according to the second mapping relation information and the first index.

In some possible implementations, receiving, by the network device, the indication information sent by the terminal device includes that the network device receives a Radio Resource Control (RRC) message sent by the terminal device, and the RRC message includes the indication information.

In a third aspect, a method for reporting a spectrum is provided. The method includes that a terminal device acquires a first frequency point through a cell search; the terminal device determines a second frequency band supported by the terminal device among multiple frequency bands corresponding to the first frequency point; the terminal device generates indication information according to the second frequency band, wherein the indication information is used for the network device to determine a schedulable spectrum range of the terminal device, or the indication information is used for indicating the spectrum range; and the terminal device sends the indication information to the network device.

In some possible implementations, the indication information is more specifically used for indicating that a frequency band supported by the terminal device is the second frequency band.

In some possible implementations, the method further includes that the terminal device initiates a random access procedure to the network device according to the indication information.

In a fourth aspect, a method for reporting a spectrum is provided. The method includes that a network device receives indication information sent by a terminal device, wherein the indication information is used for the network device to determine a schedulable spectrum range of the terminal device, or the indication information is used for indicating the spectrum range; and the network device determines the spectrum range according to the indication information.

In some possible implementations, the indication information is more specifically used for indicating that a frequency band supported by the terminal device is a second frequency band.

In some possible implementations, the method further includes that the network device responds to a random access procedure initiated by the terminal device according to the spectrum range.

In a fifth aspect, a terminal device is provided, which includes a processing unit and a transceiving unit.

The processing unit is configured to acquire a first frequency point through a cell search.

The transceiving unit is configured to acquire a first frequency band supported by a network device through a system broadcast message.

The processing unit is further configured to determine a second frequency band supported by the terminal device among multiple frequency bands corresponding to the first frequency point; initiate a random access procedure when determining that the first frequency band and the second frequency band are the same frequency band.

In a sixth aspect, a terminal device is provided, which includes a processor and a transceiver.

The processor is configured to acquire a first frequency point through a cell search.

The transceiver is configured to acquire a first frequency band supported by a network device through a system broadcast message.

The processor is further configured to determine a second frequency band supported by the terminal device among multiple frequency bands corresponding to the first frequency point; initiate a random access procedure when determining that the first frequency band and the second frequency band are the same frequency band.

In a seventh aspect, a network device is provided, which includes a transceiving unit and a processing unit.

The transceiving unit is configured to send a first frequency band supported by the network device to a terminal device through system broadcast.

The processing unit is configured to respond to a random access procedure initiated by the terminal device.

In an eighth aspect, a network device is provided, which includes a transceiver and a processor.

The transceiver is configured to send a first frequency band supported by the network device to a terminal device through system broadcast.

The processor is configured to respond to a random access procedure initiated by the terminal device.

In a ninth aspect, a terminal device is provided, which includes a processing unit and a transceiving unit.

The processing unit is configured to acquire a first frequency point through a cell search; determine a second frequency band supported by the terminal equipment among multiple frequency bands corresponding to the first frequency point; generate indication information according to the second frequency band, wherein the indication information is used for a network device to determine a schedulable spectrum range of the terminal device, or the indication information is used for indicating the spectrum range.

The transceiving unit is configured to send the indication information to the network device.

In a tenth aspect, a terminal device is provided, which includes a processor and transceiver.

The processor is configured to acquire a first frequency point through a cell search; determine a second frequency band supported by the terminal device among multiple frequency bands corresponding to the first frequency point; generate indication information according to the second frequency band, wherein the indication information is used for a network device to determine a schedulable spectrum range of the terminal device, or the indication information is used for indicating the spectrum range.

The transceiver is configured to send the indication information to the network device.

In an eleventh aspect, a network device is provided, which includes a transceiving unit and processing unit.

The transceiving unit is configured to receive indication information sent by a terminal device, wherein the indication information is used for the network device to determine a schedulable spectrum range of the terminal device, or the indication information is used for indicating the spectrum range.

The processing unit is configured to determine the spectrum range according to the indication information.

In a twelfth aspect, a network device is provided, which includes a transceiver and a processor.

The transceiver is configured to receive indication information sent by a terminal device, wherein the indication information is used for the network device to determine a schedulable spectrum range of the terminal device, or the indication information is used for indicating the spectrum range.

The processor is configured to determine the spectrum range according to the indication information.

In a thirteenth aspect, a computer readable medium is provided, which is used for storing a computer program. The computer program includes instructions used for implementing the method implementations of any one of the first aspect to the fourth aspect.

In a fourteenth aspect, a computer chip is provided. The computer chip includes an input interface, an output interface, at least one processor, and a memory. The processor is configured to execute codes in the memory. When the codes are executed, various processes implemented by the network device, in the first aspect to the fourth aspect, may be performed by the processor.

In a fifteenth aspect, a computer chip is provided. The computer chip includes an input interface, an output interface, at least one processor, and a memory. The processor is configured to execute codes in the memory. When the codes are executed, various processes implemented by the terminal device, in the first aspect to the fourth aspect, may be performed by the processor.

In a sixteenth aspect, a communication system is provided, which includes the network device and the terminal device described above.

### BRIEF DESCRIPTION OF DRAWINGS

FIG. 1 is an example of an application scenario of the present disclosure.

FIG. 2 is a schematic flowchart of a method for random access according to an implementation of the present disclosure.

FIG. 3 is a schematic flowchart of a method for reporting a spectrum according to an implementation of the present disclosure.

FIG. 4 is a schematic block diagram of a terminal device according to an implementation of the present disclosure.

FIG. 5 is a schematic block diagram of another terminal device according to an implementation of the present disclosure.

FIG. 6 is a schematic block diagram of a network device according to an implementation of the present disclosure.

FIG. 7 is a schematic block diagram of another network device according to an implementation of the present disclosure.

### DETAILED DESCRIPTION

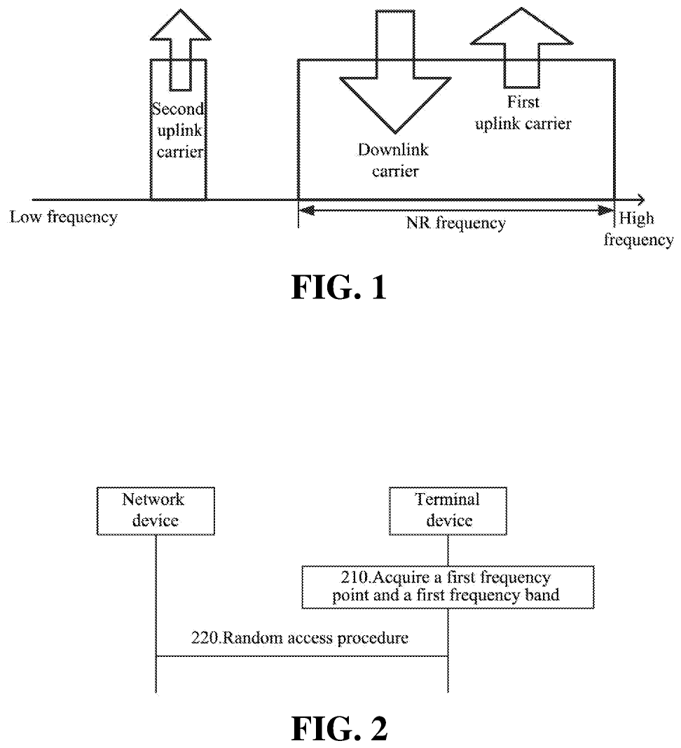

FIG. 1 is an example of an application scenario according to an implementation of the present disclosure.

As shown in FIG. 1, a terminal device may have one downlink carrier and two uplink carriers (as shown in FIG. 1, a first uplink carrier and a second uplink carrier). Specifically, the first uplink carrier and the downlink carrier may be carriers in a high frequency band of New Radio (NR), and the second uplink carrier may be a carrier in a low frequency band of Long Term Evolution (LTE). It should be understood that it is only illustrative description that the terminal device shown in FIG. 1 has two uplink carriers, implementations of the present disclosure are not specifically limited thereto. For example, the terminal device may support three uplink carriers, etc.

It should be understood that the purpose for introducing the second uplink carrier is to improve uplink coverage of the high frequency band of NR.

Specifically, uplink coverage of NR may be limited as uplink power of the terminal device is limited and frequency of an NR spectrum is relatively high (propagation loss of high frequency is high). To improve the uplink coverage, an implementation of the present disclosure provides a method for random access, which can improve an effect of the uplink coverage by using an LTE spectrum (relatively low frequency) as a supplementary uplink carrier.

For example, a combination of the first uplink carrier and the second uplink carrier may be similar to carrier aggregation (CA) in LTE, except for no paired downlink carrier. That is, from a perspective of a band combination, the second uplink carrier is a cell with only an uplink and no paired downlink, but the uplink of the cell is controlled by a certain downlink carrier, i.e., when the second uplink carrier is configured, the second uplink carrier is a secondary serving cell (SCell) without downlink, and control for the second uplink carrier depends on a primary serving cell (PCell).

It should be understood that implementations of the present disclosure may be applied to any communication system including multiple uplinks. For example, a first communication system and a second communication system may be various communication systems, such as a Global System of Mobile Communication (GSM), a Code Division Multiple Access (CDMA) system, a Wideband Code Division Multiple Access (WCDMA) system, a General Packet Radio Service (GPRS), a Long Term Evolution (LTE) system, LTE Time Division Duplex (TDD), a Universal Mobile Telecommunication System (UMTS).

In addition, various implementations are described in combination with network devices (a first network device to a fourth network device) and a terminal device in the present disclosure.

Herein, the network device may refer to any entity for sending or receiving signals at a network side. For example, the network device may be a user equipment for Machine Type Communication (MTC), a Base Transceiver Station (BTS) in GSM or CDMA, a NodeB in WCDMA, an Evolution Node B (eNB or eNodeB) in LTE, a base station device in a 5G network.

The terminal device may be any terminal device. Specifically, the terminal device may communicate with one or more core networks through a radio access network (RAN), and may also be referred to as an access terminal, a User Equipment (UE), a subscriber unit, a subscriber station, a mobile station, a remote station, a remote terminal, a mobile device, a user terminal, a terminal, a wireless communication device, a user agent, or a user device. For example, the terminal device may be a cellular phone, a cordless phone, a Session Initiation Protocol (SIP) phone, a Wireless Local Loop (WLL) station, a Personal Digital Assistant (PDA), a handheld device with a wireless communication function, a computing device, or another processing device connected to a wireless modem, a vehicle-mounted device, a wearable device, a terminal device in a 5G network or the like.

In combination with a random access procedure, it can be found that, as there is no bandwidth configuration information in SUL configuration information, similarly, in a normal NR cell, a UE only acquires frequency point information of the cell from a cell search and there is no information about a downlink bandwidth of the cell.

Moreover, in a current frequency band configuration, there may be an overlap of frequency ranges between two frequency bands, that is, one frequency point corresponds to multiple frequency bands, while a terminal device may only support one of the multiple frequency bands. For example, the terminal device does not support a frequency band in which a frequency point of the NR cell is located, but supports another frequency band in which the frequency band is located. In other words, the network device does not know a spectrum range supported by the terminal device. Thus, if scheduling of the terminal device by the network device exceeds the frequency range supported by the terminal device, data transmission and reception will fail.

Therefore, in an implementation of the present disclosure, a method for random access and a method for reporting a spectrum are proposed, so that a network device can know a frequency band or a spectrum range supported by a terminal device, thereby improving an accuracy of allocating a resource to the terminal device by the network device.

Random access according to an implementation of the present disclosure will be described below with reference to FIG. 2.

In 210, a terminal device acquires a first frequency point and a first frequency band.

In 220, the terminal device initiates a random access procedure to the network device.

Specifically, the terminal device acquires the first frequency point through a cell search; the terminal acquires the first frequency band supported by the network device through a system broadcast message; the terminal device determines a second frequency band supported by the terminal device among multiple frequency bands corresponding to the first frequency point; when determining that the first frequency band and the second frequency band are the same frequency band, the terminal device initiates the random access procedure. Correspondingly, the network device sends the first frequency band supported by the network device to the terminal device through system broadcast, and responds to the random access procedure initiated by the terminal device.

More specifically, for the terminal device, if the terminal device supports the first frequency band, the terminal device normally initiates the random access procedure.

For example, the network device sends a frequency band 1 supported by the network device to the terminal device through system broadcast. If the terminal device supports the frequency band 1, the terminal device normally initiates the random access procedure. In this situation, the network device schedules the terminal device on the frequency band 1 which does not exceed a frequency range supported by the terminal device.

However, if the terminal device does not support the first frequency band, and if the terminal device does not report this situation to the network device, the network device is likely to schedule the terminal device on the first frequency band, which causes that the scheduling of the terminal device by the network device exceeds the frequency range supported by the terminal device, thereby leading to a data transmission and reception failure.

In an implementation of the present disclosure, to solve the above-mentioned problem, the terminal device indicates to the network device a schedulable spectrum range of the terminal device or directly indicates the spectrum range through the indication information.

Specifically, when the first frequency band and the second frequency band are different frequency bands, the terminal device generates indication information, wherein the indication information is used for the network device to determine a schedulable spectrum range of the terminal device or the indication information is used for indicating the spectrum range. The terminal device sends the indication information to the network device. For the network device, the network device receives the indication information sent by the terminal device, and responds to the random access procedure according to the spectrum range.

In the implementation of the present disclosure, when the first frequency band and the second frequency band are different frequency bands, the terminal device reports the indication information to the network device such that the network device can accurately determine the schedulable spectrum range of the terminal device, thereby improving an accuracy of scheduling the terminal device by the network device.

It should be understood that the indication information in the implementation of the present disclosure is intended to let the network device know the spectrum range supported by the terminal device, and a specific form of the indication information is not limited by the implementation of the present disclosure.

For example, the indication information may be more specifically used for indicating that a frequency band supported by the terminal device is the second frequency band. Specifically, the terminal device may indicate to the network device a schedulable bandwidth range of the terminal device within the cell in a message (MSG3) of the random access procedure.

For another example, the indication information may be directly used for indicating the spectrum range, and further, the spectrum range is a range formed by an overlapping spectrum of the first frequency band and the second frequency band.

An implementation in which the terminal device sends the indication information to the network device in the implementation of the present disclosure is described below.

In an implementation, the terminal device may implicitly indicate to the network device.

For example, before generating the indication information, the terminal device receives first mapping relation information sent by the network device, wherein the first mapping relation information includes a corresponding relationship between the multiple frequency bands and multiple resources, and each of the multiple resources includes a preamble code and/or a physical random access channel (PRACH) resource. Therefore, when a frequency band supported by the terminal device is the second frequency band, the terminal device may determine a first resource corresponding to the second frequency band according to the second frequency band and the first mapping relation information. Thus, the terminal device initiates a random access procedure through the first resource and indicates that the frequency band supported by the terminal device is the second frequency band through the first resource.

For the network device, the network device determines the first resource used when the terminal device initiates the random access procedure; and the network device determines the second frequency band corresponding to the first resource as the frequency band supported by the terminal device according to the first mapping relation information.

Specifically, the terminal device may indicate the frequency band supported by the terminal device to the network device in a message (MSG3) of the random access procedure.

For another example, the terminal device receives second mapping relation information sent by the network device, wherein the second mapping relation information includes a corresponding relationship between multiple indexes and the multiple frequency bands, and the multiple indexes are different from each other. Therefore, when a frequency band supported by the terminal device is the second frequency band, the terminal device may determine a first index corresponding to the second frequency band according to the second frequency band and the second mapping relation information. Thus, the terminal device sends the first index to the network device, and the first index is used for indicating that a frequency band supported by the terminal device is the second frequency band.

For the network device, the network device receives the first index sent by the terminal device; and determines the second frequency band corresponding to the first index as the frequency band supported by the terminal device according to the second mapping relation information and the first index.

Specifically, the terminal device may indicate the frequency band supported by the terminal device to the network device in a message (MSG3) of the random access procedure.

In another implementation, the terminal device may explicitly indicate to the network device.

For example, the terminal device sends a Radio Resource Control (RRC) message to the network, wherein the RRC message includes the indication information.

It should be understood that in the implementation of the present disclosure, the above-mentioned terminal device sends the indication information to the network device. A form of the indication information is described as an example, which is not limited by the implementations of the present disclosure.

For example, the indication information may be used for indicating a frequency band not supported by the terminal device.

For example, in the implementation of the present disclosure, the first frequency point corresponds to a frequency band 1 and a frequency band 2, a frequency band supported by the network device is the frequency band 1, and a frequency band supported by the terminal device is the frequency band 2. Then, the terminal device may indicate that the frequency band supported by the terminal device is the frequency band 2, or the terminal device may indicate that the frequency band not supported by the terminal device is the frequency band 1.

After receiving the indication information, the network device may determine a schedulable spectrum range of the terminal device according to the frequency band 1 and the frequency band 2 corresponding to the first frequency point, and the indication information.

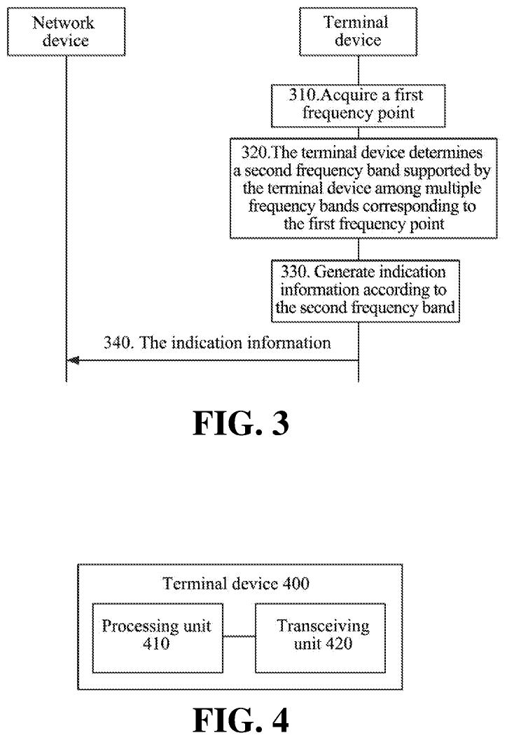

FIG. 3 is a schematic flowchart of a method for reporting a spectrum according to an implementation of the present disclosure.

As shown in FIG. 3, the method includes acts 310 to 340.

In 310, a terminal device acquires a first frequency point.

In 320, the terminal device determines a second frequency band supported by the terminal device among multiple frequency bands corresponding to the first frequency point.

In 330, the terminal device generates indication information according to the second frequency band.

In 340, the terminal device sends indication information to a network device.

Specifically, the terminal device acquires the first frequency point through a cell search; the terminal device determines the second frequency band supported by the terminal device among the multiple frequency bands corresponding to the first frequency point; the terminal device generates the indication information according to the second frequency band, wherein the indication information is used for the network device to determine a schedulable spectrum range of the terminal device, or the indication information is used for indicating the spectrum range; and the terminal device sends the indication information to the network device. In other words, the network device receives the indication information sent by the terminal device and determines the spectrum range according to the indication information.

Furthermore, the indication information is more specifically used for indicating that a frequency band supported by the terminal device is the second frequency band.

Optionally, the terminal device initiates a random access procedure to the network device according to the indication information. The network device responds to the random access procedure initiated by the terminal device according to the spectrum range.

FIG. 4 is a schematic block diagram of a terminal device according to an implementation of the present disclosure.

An implementation of the present disclosure provides a terminal device. Specifically, as shown in FIG. 4, the terminal device includes a processing unit 410 and a transceiving unit 420.

The processing unit 410 is configured to acquire a first frequency point through a cell search.

The transceiving unit 420 is configured to acquire a first frequency band supported by the network device through a system broadcast message.

The processing unit 410 is further configured to determine a second frequency band supported by the terminal device among multiple frequency bands corresponding to the first frequency point; when determining that the first frequency band and the second frequency band are the same frequency band, initiate a random access procedure.

Optionally, the processing unit 410 is further configured to generate indication information when the first frequency band and the second frequency band are different frequency bands, wherein the indication information is used for the network device to determine a schedulable spectrum range of the terminal device, or the indication information is used for indicating the spectrum range. The transceiving unit 420 is further configured to send the indication information to the network device.

Optionally, the indication information is more specifically used for indicating that a frequency band supported by the terminal device is the second frequency band.

Optionally, the spectrum range is a range formed by an overlapping spectrum of the first frequency band and the second frequency band.

Optionally, the transceiving unit 420 is further configured to, before the processing unit 410 generates the indication information, receive first mapping relation information sent by the network device, wherein the first mapping relation information includes a corresponding relationship between the multiple frequency bands and multiple resources, and each of the multiple resources includes a preamble code and/or a physical random access channel (PRACH) resource.

The processing unit 410 is further configured to determine a first resource corresponding to the second frequency band according to the second frequency band and the first mapping relation information; initiate a random access procedure through the first resource and indicate that the frequency band supported by the terminal device is the second frequency band through the first resource by the terminal device.

Optionally, the transceiving unit 420 is further configured to, before the processing unit 410 generates the indication information, receive second mapping relation information sent by the network device, wherein the second mapping relation information includes a corresponding relationship between multiple indexes and the multiple frequency bands, and the multiple indexes are different from each other. The processing unit 410 is further configured to determine a first index corresponding to the second frequency band according to the second frequency band and the second mapping relation information. The transceiving unit 420 is further configured to send the first index to the network device, wherein the first index is used for indicating that a channel supported by the terminal device is the second frequency band.

Optionally, the transceiving unit 420 is specifically configured to send a Radio Resource Control (RRC) message to the network device, wherein the RRC message includes the indication information.

Another terminal device is provided by an implementation of the present disclosure. Specifically, as shown in FIG. 4, the terminal device includes a processing unit 410 and a transceiving unit 420.

The processing unit 410 is configured to acquire a first frequency point through a cell search; determine a second frequency band supported by the terminal device among multiple frequency bands corresponding to the first frequency point; generate indication information according to the second frequency band, wherein the indication information is used for a network device to determine a schedulable spectrum range of the terminal device, or the indication information is used for indicating the spectrum range.

The transceiving unit 420 is configured to send the indication information to the network device.

Optionally, the indication information is more specifically used for indicating that a frequency band supported by the terminal device is the second frequency band.

Optionally, the processing unit 410 is further configured to initiate a random access procedure to the network device according to the indication information.

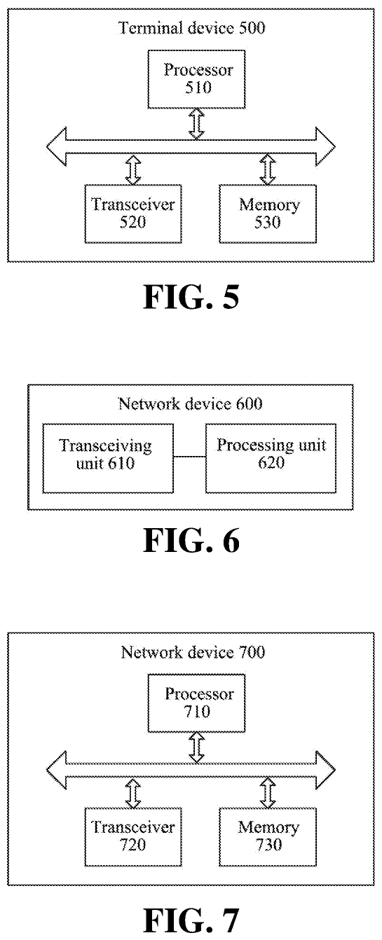

It should be noted that the processing unit 410 may be implemented by a processor, and the transceiving unit 420 may be implemented by a transceiver. As shown in FIG. 5, a terminal device 500 may include a processor 510, a transceiver 520, and a memory 530. Herein, the memory 530 may be used for storing indication information, or may be used for storing codes, instructions or the like to be executed by the processor 510. Various components in the terminal device 500 are connected by a bus system. Herein, the bus system includes a power bus, a control bus and a status signal bus in addition to a data bus.

The terminal device 500 shown in FIG. 5 can implement various processes implemented by the terminal device in the method implementations of FIG. 2 and FIG. 3 described above. In order to avoid duplication, the details will not be repeated here.

FIG. 6 is a schematic block diagram of a network device according to an implementation of the present disclosure.

An implementation of the present disclosure provides a network device. Specifically, as shown in FIG. 6, the network device includes a transceiving unit 610 and a processing unit 620.

The transceiving unit 610 is configured to send a first frequency band supported by the network device to a terminal device through system broadcast.

The processing unit 620 is configured to respond to a random access procedure initiated by the terminal device.

Optionally, the transceiving unit 610 is further configured to receive indication information sent by the terminal device, wherein the indication information is used for the network device to determine a schedulable spectrum range of the terminal device, or the indication information is used for indicating the spectrum range. Herein, the processing unit 620 is specifically configured to response to the random access procedure according to the spectrum range.

Optionally, the indication information is more specifically used for indicating that a frequency band supported by the terminal device is the second frequency band.

Optionally, the spectrum range is a range formed by an overlapping spectrum of the first frequency band and the second frequency band.

Optionally, the transceiving unit 610 is specifically configured to, before receiving the indication information sent by the terminal device, send first mapping relation information to the terminal device, wherein the first mapping relation information includes a corresponding relationship between the multiple frequency bands and multiple resources, and each of the multiple resources includes a preamble code and/or a physical random access channel (PRACH) resource; determine a first resource used when the terminal device initiates the random access procedure; and determine a second frequency band corresponding to the first resource as the frequency band supported by the terminal device according to the first mapping relation information.

Optionally, the transceiving unit 610 is specifically configured to, before receiving the indication information sent by the terminal device, send second mapping relation information to the terminal device, wherein the second mapping relation information includes a corresponding relationship between multiple indexes and the multiple frequency bands, and the multiple indexes are different from each other; receive a first index sent by the terminal device; and determine a second frequency band corresponding to the first index as the frequency band supported by the terminal device according to the second mapping relation information and the first index.

Optionally, the transceiving unit 610 is more specifically configured to receive a Radio Resource Control (RRC) message sent by the terminal device, wherein the RRC message includes the indication information.

Another network device is provided by the implementation of the present disclosure. Specifically, as shown in FIG. 6, the network device includes a transceiving unit 610 and a processing unit 620.

The transceiving unit 610 is configured to receive indication information sent by a terminal device, wherein the indication information is used for the network device to determine a schedulable spectrum range of the terminal device, or the indication information is used for indicating the spectrum rang.

The processing unit 620 is configured to determine the spectrum range according to the indication information.

Optionally, the indication information is more specifically used for indicating that a frequency band supported by the terminal device is a second frequency band.

Optionally, the processing unit 620 is further configured to response to a random access procedure initiated by the terminal device according to the spectrum range.

It should be noted that the transceiving unit 610 may be implemented by a transceiver, and the processing unit 620 may be implemented by a processor. As shown in FIG. 7, a network device 700 may include a processor 710, a transceiver 720, and a memory 730. Herein, the memory 730 may be used for storing indication information, or may be used for storing codes, instructions or the like to be executed by the processor 710. Various components in the network device 700 are connected by a bus system. The bus system includes a power bus, a control bus and a status signal bus in addition to a data bus.

The network device 700 shown in FIG. 7 may implement various processes implemented by the network device in the method implementations of FIG. 2 and FIG. 3 described above. In order to avoid duplication, the details will not be repeated here.

It should be noted that the method implementations of the implementations of the present disclosure may be applied to the processor or be implemented by the processor.

In the implementation process, various acts of the method implementations in the implementations of the present disclosure may be completed by an integrated logic circuit of hardware in the processor or an instruction in the form of software. More specifically, the acts of the method disclosed in connection with the implementations of the present disclosure may be directly embodied as completion through the execution of a hardware decoding processor or completion through the execution in the combination of hardware in the decoding processor and software modules. Software modules may be located in a mature storage medium in the art, such as, a random access memory (RAM), a flash memory, a read-only memory, a programmable read-only memory, an electrical erasable programmable memory, or a register. The storage medium is located in the memory, and the processor reads information in the memory and completes the acts of the above methods in combination with its hardware.

Herein, the processor may be an integrated circuit chip with a capability for processing signals, and may perform or implement various methods, acts and logic block diagrams disclosed in the implementations of the present disclosure. For example, the above processor may be a general purpose processor, a digital signal processor (DSP), an application specific integrated circuit (ASIC), a field programmable gate array (FPGA) or other programmable logic devices, a transistor logic device, or a discrete hardware component, or the like. Furthermore, the general purpose processor may be a microprocessor or the processor may be any conventional processor or the like.

In addition, the memory in implementations of the present disclosure may be a transitory memory or non-transitory memory, or may include both the transitory memory and the non-transitory memory. The non-transitory memory may be a read-only memory (ROM), a programmable ROM (PROM), an erasable PROM (EPROM), an electrically erasable EPROM (EEPROM), or a flash memory. The transitory memory may be a Random Access Memory (RAM) which serves as an external cache. It should be understood that, the foregoing memory is an example for illustration and should not be construed as limiting. For example, optionally, the memory in the implementations of the present disclosure may be a Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), Direct Rambus RAM (DR RAM), or the like. That is, memories in the systems and methods described herein are intended to include, but are not limited to, these and any other suitable types of memories.

Finally, it should be noted that terms used in the implementations of the present disclosure and appended claims are for a purpose of describing specific implementations only and are not intended to limit the implementations of the present disclosure.

For example, a singular form of “a”, “said”, and “the” used in the implementations of the present disclosure and the appended claims are also intended to include a plural form unless a context clearly indicates other meanings.

For another example, depending on the context, a phase “when” as used herein may be interpreted as “if” or “whether” or “while” or “in response to a determination” or “in response to a detection”. Similarly, depending on the context, a phrase “if determining” or “if detecting (a stated condition or event)” may be interpreted as “when . . . is determined” or “in response to a determination” or “when (a stated condition or event) is detected” or “in response to a detection of (stated condition or event)”.

Those of ordinary skill in the art will recognize that the example elements and algorithm acts described in combination with the implementations disclosed herein can be implemented in electronic hardware, or a combination of computer software and electronic hardware. Whether these functions are implemented in hardware or software depends on the specific application and design constraints of the technical solution. One skilled in the art may use different methods to implement the described functions for each specific application, but such implementation should not be considered to be beyond the scope of implementations of the present disclosure.

Those skilled in the art may clearly understand that for convenience and conciseness of description, the specific working processes of the systems, apparatuses and units described above may refer to the corresponding processes in the method implementations and will not be described here.

In several implementations provided by the present disclosure, it should be understood that the disclosed systems, devices and methods may be implemented in other ways. For example, the device implementations described above are only illustrative, for example, the division of the units is only a logical function division, and there may be other division modes in actual implementation, for example, multiple units or components may be combined or integrated into another system, or some features may be ignored or not executed. On the other hand, the mutual coupling or direct coupling or communication connection shown or discussed may be indirect coupling or communication connection through some interfaces, apparatuses or units, and may be in electrical, mechanical or other forms.

The units described as separate components may or may not be physically separated, and the component shown as a unit may or may not be a physical unit, i.e., it may be located in one place or may be distributed over multiple network units. Parts or all of the units can be selected according to actual needs to achieve the purpose of the implementations of the present disclosure.

In addition, various functional units in the implementations of the present disclosure may be integrated in one processing unit, or various units may be presented separately in a physical way, or two or more units may be integrated in one unit.

The function units may be stored in a computer readable storage medium if realized in a form of software functional units and sold or used as a separate product. Based on this understanding, the technical solutions of the implementations of the present disclosure, in essence, or the part contributing to the related art, or the part of the technical solutions, may be embodied in the form of a software product stored in a storage medium, including several instructions for causing a computer device (which may be a personal computer, a server, or a network device, etc.) to perform all or parts of the acts of the methods described in various implementations of the present disclosure. The aforementioned storage medium includes a medium capable of storing program codes, such as, a U disk, a mobile hard disk, a read-only memory (ROM), a random access memory, a magnetic disk or an optical disk, etc.

What are described above are merely the specific implementations of the implementations of the present disclosure, but the protection scope of the implementations of the present disclosure is not limited thereto. Any change or substation that can be easily conceived by any person skilled in the art within the technical scope disclosed by the implementations of the present disclosure shall be included within the protection scope of the implementations of the present disclosure. Therefore, the scope of protection of the implementations of the present disclosure should be subject to the scope of protection of the claims.

What is claimed is:

1. A method for random access, comprising:
acquiring, by a terminal device, a first frequency point through a cell search;
acquiring, by the terminal device, a first frequency band supported by a network device through a system broadcast message;
determining, by the terminal device, a second frequency band supported by the terminal device among a plurality of frequency bands corresponding to the first frequency point; and
initiating, by the terminal device, a random access procedure when determining the first frequency band and the second frequency band are the same frequency band.

2. The method of claim 1, further comprising:
generating, by the terminal device, indication information when the first frequency band and the second frequency band are different frequency bands, wherein the indication information is used for the network device to determine a schedulable spectrum range of the terminal device, or the indication information is used for indicating the spectrum range; and
sending, by the terminal device, the indication information to the network device.

3. The method of claim 2, wherein the indication information is used for indicating that a frequency band supported by the terminal device is the second frequency band.

4. The method of claim 2, wherein the spectrum range is a range formed by an overlapping spectrum of the first frequency band and the second frequency band.

5. The method of claim 2, further comprising:
before generating, by the terminal device, the indication information:
receiving, by the terminal device, first mapping relation information sent by the network device, wherein the first mapping relation information comprises a corresponding relationship between the plurality of frequency bands and a plurality of resources, and each of the plurality of resources comprises a preamble code and/or a physical random access channel (PRACH) resource; and
determining, by the terminal device, a first resource corresponding to the second frequency band according to the second frequency band and the first mapping relation information;
wherein sending, by the terminal device, the indication information to the network device comprises:
initiating, by the terminal device, the random access procedure through the first resource and indicating, through the first resource, that a frequency band supported by the terminal device is the second frequency band.

6. The method of claim 2, further comprising:
before generating, by the terminal device, the indication information:
receiving, by the terminal device, second mapping relation information sent by the network device, wherein the second mapping relation information comprises a corresponding relationship between a plurality of indexes and the plurality of frequency bands, and the plurality of indexes are different from each other; and
determining, by the terminal device, a first index corresponding to the second frequency band according to the second frequency band and the second mapping relation information;
wherein sending, by the terminal device, the indication information to the network device comprises:
sending, by the terminal device, the first index to the network device, wherein the first index is used for indicating a frequency band supported by the terminal device is the second frequency band.

7. The method of claim 2, wherein sending, by the terminal device, the indication information to the network device comprises:
sending, by the terminal device, a Radio Resource Control (RRC) message to the network device, wherein the RRC message comprises the indication information.

8. A method for random access, comprising:
sending, by a network device, a first frequency band supported by the network device to a terminal device through system broadcast; and
responding, by the network device, to a random access procedure initiated by the terminal device.

9. The method of claim 8, further comprising:
receiving, by the network device, indication information sent by the terminal device, wherein the indication information is used for the network device to determine a schedulable spectrum range of the terminal device, or the indication information is used for indicating the spectrum range;
wherein, responding, by the network device, to the random access procedure initiated by the terminal device comprises:
responding, by the network device, to the random access procedure according to the spectrum range.

10. The method of claim 9, wherein the indication information is used for indicating that a frequency band supported by the terminal device is a second frequency band.

11. The method of claim 9, wherein the spectrum range is a range formed by an overlapping spectrum of the first frequency band and a second frequency band.

12. The method of claim 9, further comprising:
before receiving, by the network device, the indication information sent by the terminal device,
sending, by the network device, first mapping relation information to the terminal device, wherein the first mapping relation information comprises a corresponding relationship between a plurality of frequency bands and a plurality of resources, and each of the plurality of resources comprises a preamble code and/or a physical random access channel (PRACH) resource;
wherein receiving, by the network device, the indication information sent by the terminal device comprises:
determining, by the network device, a first resource used when the terminal device initiates the random access procedure; and
determining, by the network device, a second frequency band corresponding to the first resource as a frequency band supported by the terminal device according to the first mapping relation information.

13. The method of claim 9, further comprising:
before receiving, by the network device, the indication information sent by the terminal device,
sending, by the network device, second mapping relation information to the terminal device, wherein the second mapping relation information comprises a corresponding relationship between a plurality of indexes and a plurality of frequency bands, and the plurality of indexes are different from each other;
wherein receiving, by the network device, the indication information sent by the terminal device comprises:
receiving, by the network device, a first index sent by the terminal device; and
determining, by the network device, a second frequency band corresponding to the first index as a frequency band supported by the terminal device according to the second mapping relation information and the first index.

14. The method of claim 9, wherein receiving, by the network device, the indication information sent by the terminal device comprises:
receiving, by the network device, a Radio Resource Control (RRC) message sent by the terminal device, wherein the RRC message comprises the indication information.

15. A terminal device, comprising a processor and a transceiver, wherein:
the processor is configured to:
acquire a first frequency point through a cell search;
determine a second frequency band supported by the terminal device among a plurality of frequency bands corresponding to the first frequency point; and
generate indication information according to the second frequency band, wherein the indication information is used for a network device to determine a schedulable spectrum range of the terminal device, or the indication information is used for indicating the spectrum range; and
the transceiver is configured to send the indication information to the network device.

16. The terminal device of claim 15, wherein the indication information is used for indicating that a frequency band supported by the terminal device is the second frequency band.

17. The terminal device of claim 15, wherein the processor is further configured to:
initiate a random access procedure to the network device according to the indication information.

18. A network device, comprising a processor and a transceiver, wherein:
the transceiver is configured to receive indication information sent by a terminal device, wherein the indication information is used for the network device to determine a schedulable spectrum range of the terminal device, or the indication information is used for indicating the spectrum range; and
the processor is configured to determine the spectrum range according to the indication information.

19. The network device of claim 18, wherein the indication information is used for indicating that a frequency band supported by the terminal device is a second frequency band.

20. The network device of claim 18, wherein the processor is further configured to:
respond to a random access procedure initiated by the terminal device according to the spectrum range.
